(19) United States
(12) Patent Application Publication
(10) Pub. No.: US 2020/0011685 A1
(43) Pub. Date: Jan. 9, 2020

(54) ROUTE SEARCHING DEVICE AND COMPUTER PROGRAM

(71) Applicants: AISIN AW CO., LTD., Anjo-shi, Aichi-ken (JP); TOYOTA JIDOSHA KABUSHIKI KAISHA, Toyota-shi, Aichi-ken (JP)

(72) Inventors: Sadahiro KOSHIBA, Takahama (JP); Kazuteru MAEKAWA, Miyoshi (JP); Koichi USHIDA, Okazaki (JP); Hiroyuki TASHIRO, Kitakyushu (JP); Tomohiko MASUTANI, Kitakyushu (JP); Tomoko ARITA, Munakata (JP); Motohiro NAKAMURA, Okazaki (JP); Atsushi IKENO, Kyoto-shi (JP); Yoshitaka KATO, Anjo (JP)

(73) Assignees: AISIN AW CO., LTD., Anjo-shi, Aichi-ken (JP); TOYOTA JIDOSHA KABUSHIKI KAISHA, Toyota-shi, Aichi-ken (JP)

(21) Appl. No.: 16/490,795

(22) PCT Filed: Mar. 28, 2018
(86) PCT No.: PCT/JP2018/012655

§ 371 Date: Sep. 3, 2019

(30) Foreign Application Priority Data
Mar. 28, 2017 (JP) 2017-063044

(51) Int. Cl. G01C 21/34; G08G 1/0967; G08G 1/0969; G08G 1/01

(52) U.S. Cl. CPC G01C 21/3453; G01C 21/3446; G08G 1/012; G08G 1/0969; G08G 1/096775

(57) ABSTRACT

Route search devices and programs obtain network data including nodes and links, and link information including (i) travel times for traveling a link included in the network data, the nodes and the links representing a road network, and (ii) for each entry link or each exit link, information that identifies a value representing statistical variation of travel times for the link, the entry link being a link entering a node at one end of the link, and the exit link being a link exiting from a node at another end of the link. The devices and programs search for a recommended route by taking into account (i) a travel time to a destination, based on the network data and the link information, and (ii) cost values identified based on a representative value of travel times for a link and a value representing statistical variation of the travel times.

### TECHNICAL FIELD

Related technical fields include route searching devices and computer programs that search for a recommended route using cost values.

### BACKGROUND

In recent years, a navigation device that provides vehicle travel guidance so that a driver can easily reach a desired destination has been often mounted on a vehicle. Here, the navigation device is a device that can detect a current location of the vehicle by a GPS receiver, etc., obtain map data for the current location through a recording medium such as a DVD-ROM or an HDD or a network, and display the map data on a liquid crystal monitor. Furthermore, such a navigation device has a route search function that searches for, when a desired destination is inputted, an optimal route from a vehicle location to the destination, and sets the optimal route searched for, as a guided route, and displays the guided route on a display screen and provides audio guidance when, for example, the vehicle approaches an intersection, and thereby securely guides a user to the desired destination. In addition, in recent years, even some of mobile phones, smartphones, tablet terminals, personal computers, etc., have had the same functions as the above-described navigation device.

In addition, the above-described route search function generally uses Dijkstra's algorithm as a route search method for searching for a route from a point of departure to a destination. Here, in Dijkstra's algorithm, for each link included in the route, a cost value indicating the level of appropriateness of the link as the route is calculated, and an optimal route is identified based on the added value of the calculated costs. In addition, for a calculation method for a cost value, calculation is performed using travel times which are the time required for vehicles to pass through a link. Here, travel times for a link are collected using, for example, probe information or vehicle sensors or optical beacons installed on a road, but since the speed and travel mode vary from vehicle to vehicle, variation occurs in travel times to be collected. Thus, to calculate an accurate cost value, variation in travel times has also needed to be taken into account.

For example, JP 2015-161557 A discloses that travel times for a link are collected using probe data, and a cost value of a route is calculated using a function including the mean and value of variation of travel times.

### SUMMARY

Here, it is known that a distribution of travel times for a link to be collected greatly varies depending on from which link a vehicle enters the link and to which link the vehicle exits from the link, due to the influence of signal control, etc. For example, in order for traffic lights to minimize impediments to traffic flow, the turn-on of traffic lights installed in the same direction is synchronized between the traffic lights. Specifically, as shown in FIG. 13, when three traffic lights 101 to 103 are installed continuously in a straight-ahead direction, timing at which each of the traffic lights 101 to 103 switches from “green”→“yellow”→“red” is often synchronized between the traffic lights 101 to 103. As a result, when, as shown in FIG. 13, a vehicle travels straight ahead, deceleration is not required and thus a travel time for each link is reduced. On the other hand, when, as shown in FIG. 14, a vehicle passes though by making left and right turns, since the traffic light 102 is “red” at timing at which a traffic light 104 is “green”, it is highly likely that the vehicle stops at the traffic light 102. In addition, it is expected that even after the traffic light 102 turns “green”, the vehicle waits at the traffic light 103 to make a right turn. As described above, the travel time for a link greatly varies, even for the same link, depending on from which link the vehicle enters the link and to which link the vehicle exits from the link.

However, a technique described in the above-described JP 2015-161557 A has not taken into account a link to enter or a link to exit such as that described above, and thus, there has been a problem that even if statistics of collected travel times for a link are gathered, the accurate mean and value of variation of the travel times cannot be calculated, and as a result, an appropriate cost value cannot be identified.

Exemplary embodiments of the broad inventive principles described herein solve the above-described conventional problem, and provide a route searching device and a computer program that are capable of rapidly searching for a recommended route by identifying more appropriate cost values by allowing to have information that identifies statistical variation of travel times for a link, with travel times segmented by each link to enter or each link to exit.

Exemplary embodiments provide route search devices and programs that obtain network data including nodes and links, and link information including (i) travel times for traveling a link included in the network data, the nodes and the links representing a road network, and (ii) for each entry link or each exit link, information that identifies a value representing statistical variation of travel times for the link, the entry link being a link entering a node at one end of the link, and the exit link being a link exiting from a node at another end of the link. The devices and programs search for a recommended route by taking into account (i) a travel time to a destination, based on the network data and the link information, and (ii) cost values identified based on a representative value of travel times for a link and a value representing statistical variation of the travel times.

According to the route searching device and the computer program according that have the above-described configurations, a link for which costs are to be identified is allowed to have information associated therewith that identifies statistical variation of travel times for the link, with travel times segmented by each entry link or each exit link. By this, the accurate value of variation based on travel modes can be identified, and as a result, it becomes possible to identify more appropriate cost values. Then, by using the identified cost values, it becomes possible to rapidly search for a more appropriate recommended route for a user.

### BRIEF DESCRIPTION OF DRAWINGS

FIG. 1 is a schematic configuration diagram showing a route search system according to the present embodiment.

FIG. 2 is a block diagram showing a configuration of the route search system according to the present embodiment.

FIG. 3 is a diagram showing examples of distributions of travel times for a link, the statistics of which are gathered for each combination of an entry link and an exit link.

FIG. 4 is a diagram showing examples of distributions of travel times for a link, the statistics of which are gathered for each exit link.

FIG. 5 is a diagram showing examples of distributions of travel times for a link, the statistics of which are gathered for each entry link.

FIG. 6 is a diagram showing a data structure of link data.

FIG. 7 is a block diagram schematically showing a control system of a navigation device according to the present embodiment.

FIG. 8 is a flowchart of a probe information statistical processing program according to the present embodiment.

FIG. 9 is a flowchart of a route search processing program according to the present embodiment.

FIG. 10 is an illustrative diagram showing a specific example in which search branches are extended in a route search process.

FIG. 11 is an illustrative diagram showing the specific example in which search branches are extended in a route search process.

FIG. 12 is an illustrative diagram showing a method of excluding unnecessary labels from among candidate labels provided to a node of interest in the route search process.

FIG. 13 is a diagram describing a problem of conventional art.

FIG. 14 is a diagram describing the problem of conventional art.

### DETAILED DESCRIPTION OF EXEMPLARY EMBODIMENTS

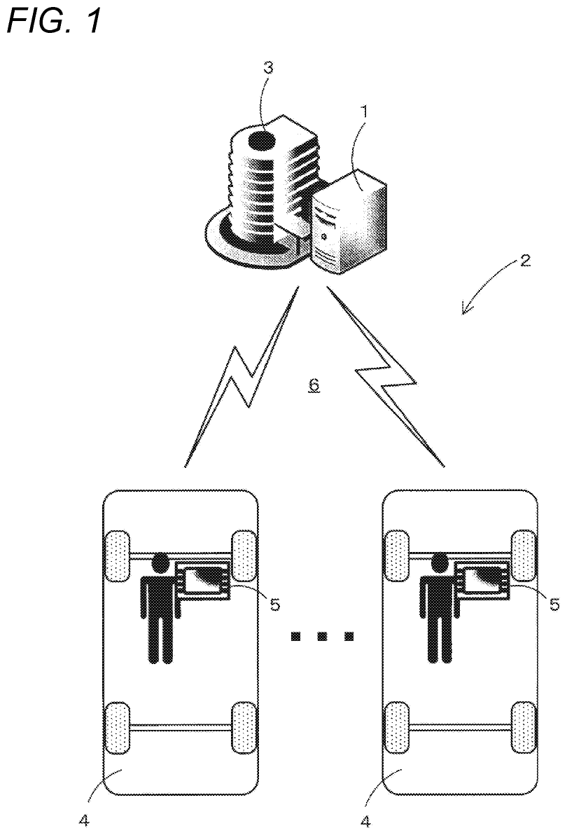

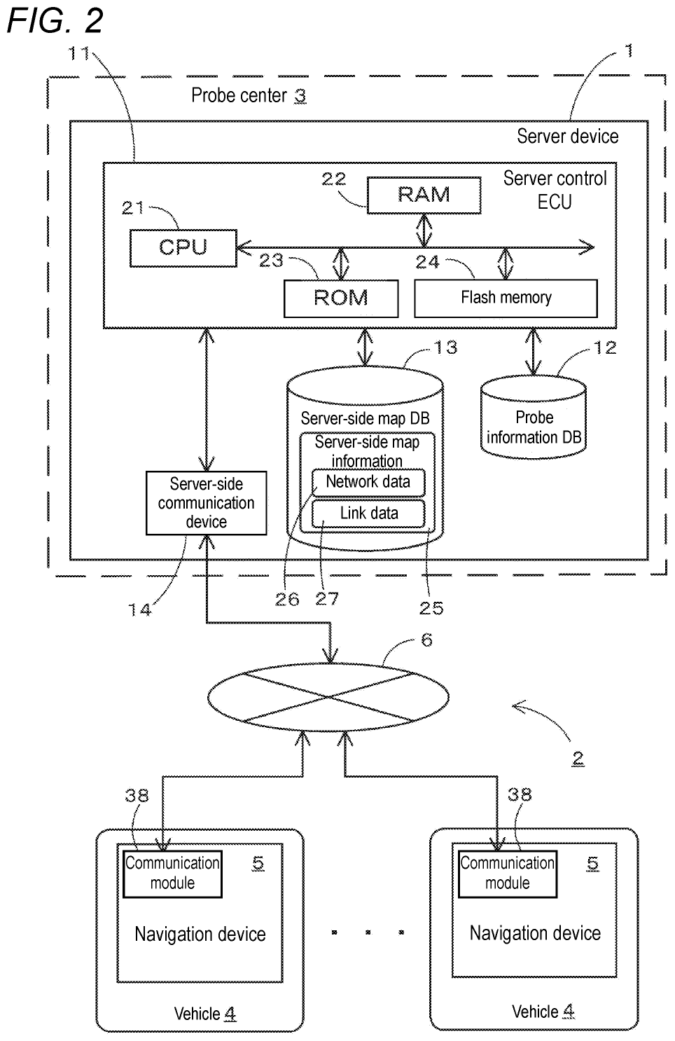

A route searching device will be described in detail below based on one embodiment in which the route searching device is embodied into a server device, and with reference to the drawings. First, a schematic configuration of a route search system 2 including a server device 1 according to the present embodiment will be described using FIGS. 1 and 2. FIG. 1 is a schematic configuration diagram showing the route search system 2 according to the present embodiment. FIG. 2 is a block diagram showing a configuration of the route search system 2 according to the present embodiment.

As shown in FIG. 1, the route search system 2 according to the present embodiment basically includes the server device (route searching device) 1 provided in a probe center 3; and navigation devices 5 which are communication terminals mounted on vehicles 4. In addition, the server device 1 and the navigation devices 5 are configured to be able to perform transmission and reception of electronic data with each other through a communication network 6. Note that instead of the navigation devices 5, for example, mobile phones, smartphones, tablet terminals, or personal computers may be used.

Here, the server device 1 provided in the probe center 3 is an information delivery server that collects and accumulates probe information (material information) including a current time, travel information, etc., from each vehicle traveling across the country, and generates various types of assistance information about roads (e.g., road closed information, accident information, congestion information, and travel times) from the accumulated probe information, and delivers the generated assistance information to the navigation devices 5 or performs various types of processes using the assistance information. Particularly, in the present embodiment, the server device 1 collects, from each vehicle, a travel time which is the time required to pass through a link, and calculates, from a distribution of the collected travel times for the link, each of a representative value (e.g., a mean, a median, or a mode) of the travel times for the link and a value representing statistical variation (e.g., a standard deviation) of the travel times for the link.

In addition, the server device 1 includes the latest version of map information, and also performs a route search using the calculated “representative values of travel times for links and values representing statistical variation of the travel times for the links” described above, in response to a request from a navigation device 5. Specifically, when a destination is set on a navigation device 5, information required for a route search such as a point of departure and a destination is transmitted from the navigation device 5 to the server device 1, together with a route search request. Then, the server device 1 having received the route search request performs a route search using the map information included in the server device 1, the “representative values of travel times for links and values representing statistical variation of the travel times for the links” calculated based on probe information, etc., and identifies a recommended route (center route) from the point of departure to the destination. Thereafter, route information about the identified recommended route is transmitted to the navigation device 5 which is the request source. Then, the navigation device 5 sets a guided route using the route information received from the server device 1.

Note, however, that a route search process does not necessarily need to be performed by the server device 1, and may be performed by the navigation device 5. In that case, information about the “representative values of travel times for links and values representing statistical variation of the travel times for the links” calculated based on probe information is delivered from the server device 1 to the navigation device 5, and the navigation device 5 performs a route search based on the delivered information, map information included in the navigation device 5, etc.

Meanwhile, the navigation devices 5 each are an in-vehicle device that is mounted on a vehicle 4, and displays a map around the location of the vehicle 4 based on map data stored therein, displays the current location of the vehicle in a map image, or provides moving guidance along a set guided route. In addition, the navigation device 5 also provides a user with guidance on traffic information such as the level of congestion which is received from the server device 1. Note that the details of the navigation device 5 will be described later.

In addition, the communication network 6 includes multiple base stations disposed all over the country and telecommunications companies that manage and control the base stations, and is formed by connecting the base stations to the telecommunications companies by wire (optical fiber, ISDN, etc.) or wirelessly. Here, each base station includes a transceiver and an antenna that perform communication with navigation devices 5. While the base station performs radio communication with a telecommunications company, the base station serves as an end of the communication network 6 and plays a role in relaying communication of navigation devices 5 present in an area (cell) in which radio waves from the base station reach, with the server device 1.

Next, a configuration of the server device 1 in the route search system 2 will be described in more detail using FIG. 2. The server device 1 includes, as shown in FIG. 2, a server control ECU 11; a probe information DB 12 serving as information recording means and connected to the server control ECU 11; a server-side map DB 13, and a server-side communication device 14.

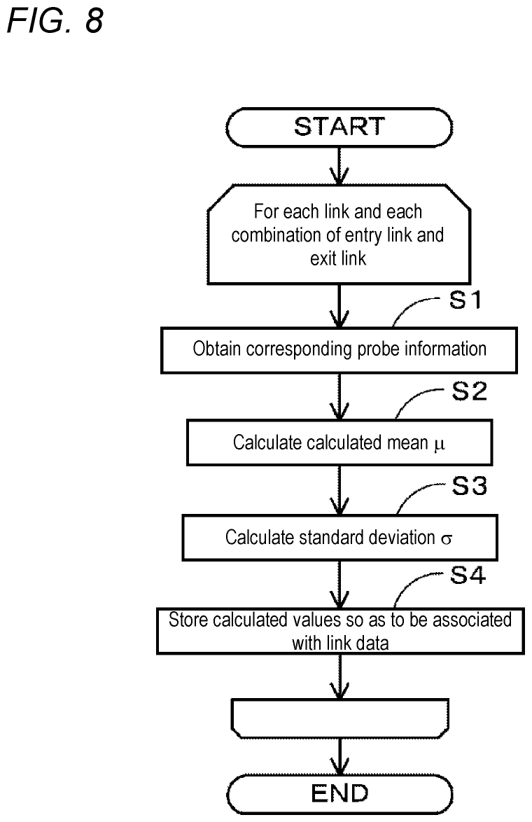

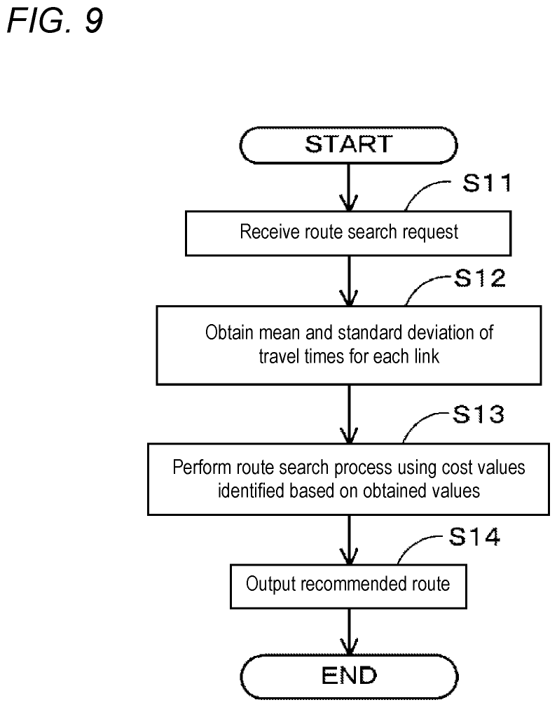

The server control ECU 11 (electronic control unit) is an electronic control unit that performs overall control of the server device 1, and includes a CPU 21 serving as a computing device and a control device; and internal storage devices such as a RAM 22 used as a working memory when the CPU 21 performs various types of arithmetic processing, a ROM 23 having recorded therein a probe information statistical processing program (FIG. 8) and a route search processing program (see FIG. 9) which will be described later, etc., in addition to a program for control, and a flash memory 24 that stores a program read from the ROM 23. Note that the server control ECU 11 includes various types of means serving as processing algorithms with an ECU of a navigation device 5 which will be described later. For example, information obtaining means obtains network data including nodes and links that represent a road network, and link information including travel times for traveling a link included in the network data. Route searching means searches for a recommended route taking into account a travel time to a destination, based on the network data and the link information.

In addition, the probe information DB 12 is storage means for cumulatively storing probe information collected from each vehicle 4 traveling across the country. Note that in the present embodiment, for example, probe information collected from a vehicle 4 includes (a) date and time, (b) a link along which the vehicle travels (also including an entry link and an exit link), (c) a traveling direction of the vehicle, (d) time required for the vehicle to pass through the link (hereinafter, referred to as a travel time), etc. Note, however, that the probe information does not necessarily need to include all information about the above-described (a) to (d), and may be configured to include only information about, for example, (b), (c), and (d).

Then, the server device 1 generates assistance information about roads across the country by gathering statistics of probe information stored in the probe information DB 12. Particularly, in the present embodiment, the server device 1 collects, from each vehicle 4, a travel time which is the time required to pass through a link, as probe information, and calculates, from a distribution of the collected travel times for the link, each of a representative value (e.g., a mean, a median, or a mode) of the travel times for the link and a value representing statistical variation (e.g., a standard deviation) of the travel times for the link. Then, the server device 1 identifies cost values of the link which are used for a route search, based on the representative value of the travel times for the link and the value representing statistical variation of the travel times for the link.

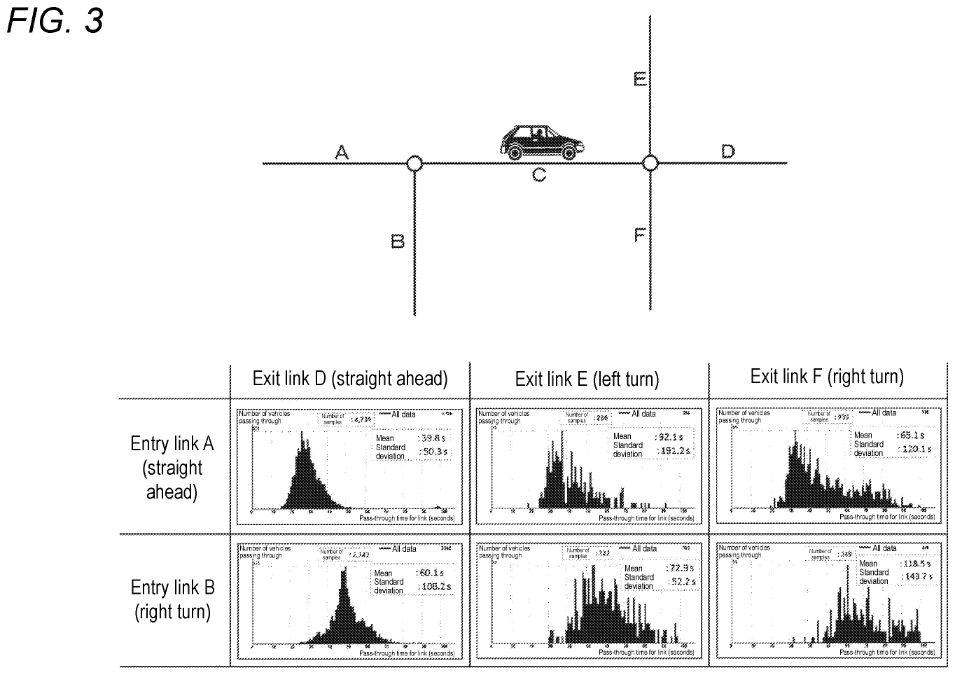

For example, FIG. 3 is a diagram showing, as examples of probe information, distributions of travel times for a link C which are collected from each vehicle 4 having traveled along the link C. Here, in the present embodiment, statistics of travel times for a link are gathered for each entry link which is a link entering a node at one end of the link and for each exit link which is a link exiting from a node at the other end of the link. In the example shown in FIG. 3, a link A and a link B are present as entry links and links D to F are present as exit links, and thus, statistics of travel times for the link are gathered separately for six (=2×3) sections. For example, a distribution diagram shown in the upper left of FIG. 3 shows a result of selecting only those travel times for a link for a case of entering the link C from the link A and exiting to the link D, from the probe information DB 12 and gathering statistics of the selected travel times. Then, the server device 1 calculates, for each entry link and each exit link, a mean which is a representative value of travel times for a link and a standard deviation which is a value representing statistical variation of the travel times for the link.

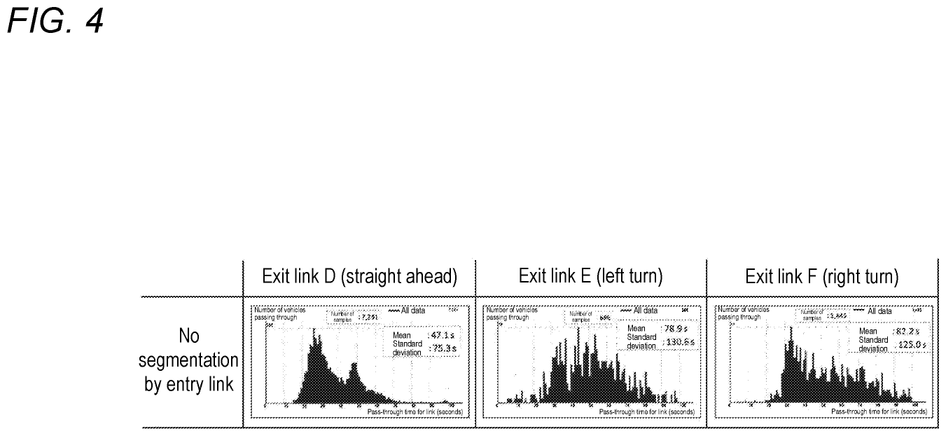

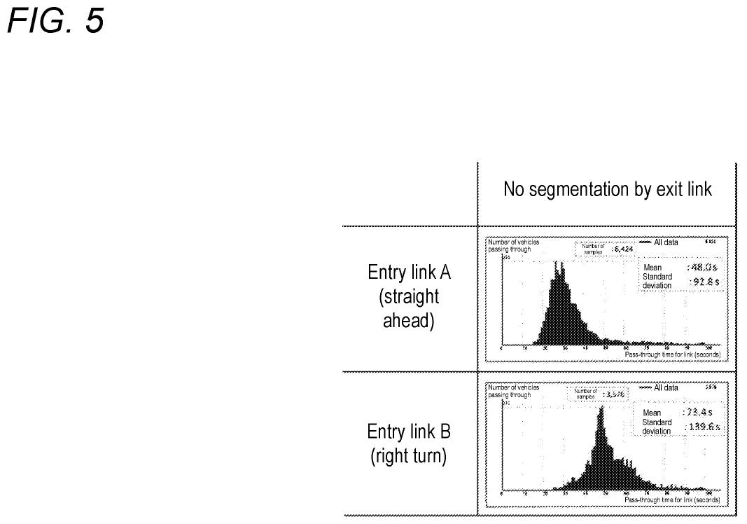

Note, however, that statistics of travel times for a link do not necessarily need to be gathered for each entry link and each exit link. For example, as shown in FIG. 4, statistics of travel times for a link may be gathered for each exit link without segmenting travel times by entry link. In addition, as shown in FIG. 5, statistics of travel times for a link may be gathered for each entry link without segmenting travel times by exit link.

Then, using the calculated means and standard deviations of travel times for the link, the server device 1 identifies, for each entry link and each exit link, cost values indicating the level of suitableness of the link as a route, and searches for a recommended route. Details will be described later. In addition, the server device 1 stores and manages the calculated mean and standard deviation of travel times for a link in a DB as part of link data such that mean and the standard deviation are associated with the link.

Meanwhile, the server-side map DB 13 is storage means for storing server-side map information 25 which is the latest version of map information registered based on input data from an external source or input operations. Here, the server-side map information 25 basically has the same configuration as map information stored in the navigation devices 5, and includes a road network and various types of information required for a route search, route guidance, and map display. The server-side map information 25 includes, for example, network data 26 including nodes and links that represent a road network, link data 27 about roads (links), node data about node points, intersection data about each intersection, location data about locations such as facilities, map display data for displaying a map, search data for searching for a route, and retrieval data for retrieving a location.

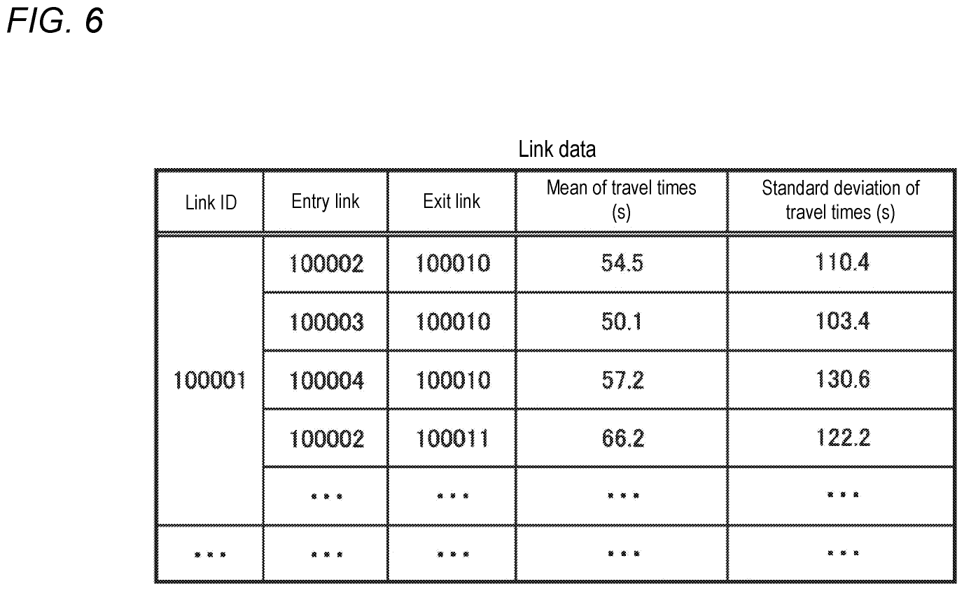

Here, particularly, the link data 27 is stored such that the mean and standard deviation of travel times for a link which are calculated by gathering statistics of probe information are associated with each other. FIG. 6 is a diagram showing an example of the link data 27 stored in the server-side map DB 13.

As shown in FIG. 6, the link data 27 includes, for each link present across the country, a link ID that identifies the link, a combination of an entry link and an exit link, and the mean and standard deviation of travel times calculated by gathering statistics of corresponding probe information. For example, the link data shown in FIG. 6 represents that, for a link with the link ID “100001”, the mean of travel times for a case of entering from the entry link “100002” and exiting from the exit link “100010” is 54.5 sec and the standard deviation of the travel times is 54.5 sec.

Note that, as described above, statistics of travel times for a link do not necessarily need to be gathered for each entry link and each exit link, and statistics of travel times for a link may be gathered for each entry link or each exit link. In that case, for the link data 27, too, the mean and standard deviation of travel times may be associated with only an entry link, or the mean and standard deviation of travel times may be associated with only an exit link.

Meanwhile, the server-side communication device 14 is a communication device for performing communication with each vehicle 4 from which probe information is to be collected and the navigation devices 5 through the communication network 6. In addition, it is also possible to receive traffic information including various information such as congestion information, regulation information, and traffic accident information which are transmitted from an Internet network or a traffic information center, e.g., a VICS (registered trademark: Vehicle Information and Communication System) center, besides the navigation devices 5.

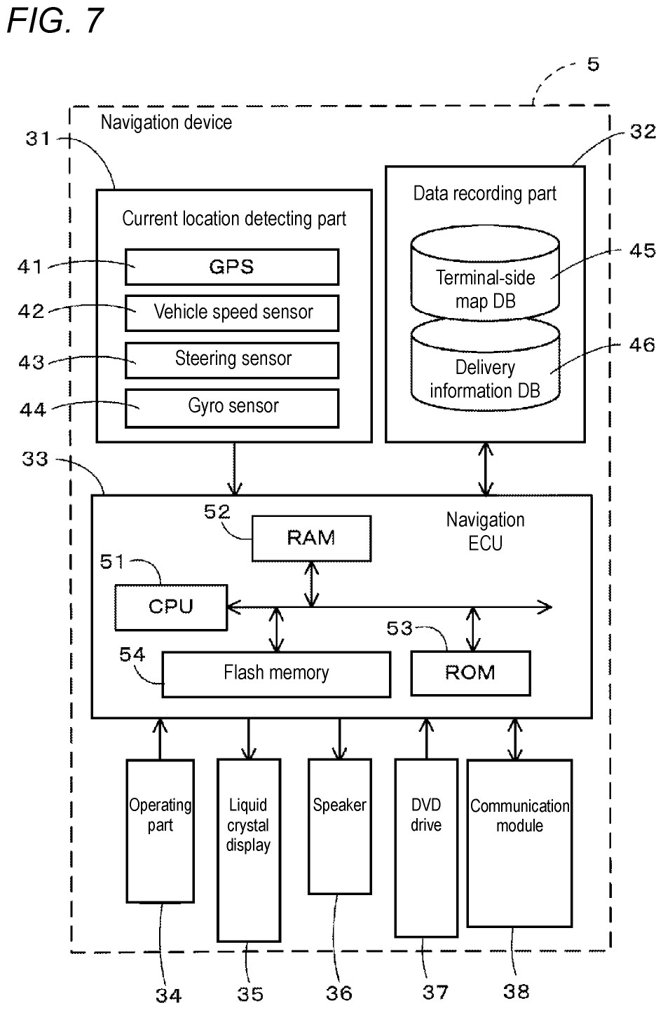

Next, a schematic configuration of each navigation device 5 will be described using FIG. 7 FIG. 7 is a block diagram schematically showing a control system of a navigation device which is the navigation device 5 according to the present embodiment.

As shown in FIG. 7, the navigation device 5 according to the present embodiment includes a current location detecting part 31 that detects a current location of a vehicle 4 having the navigation device 5 mounted thereon; a data recording part 32 having various types of data recorded therein; a navigation ECU 33 that performs various types of arithmetic processing based on inputted information; an operating part 34 that accepts operations from a user; a liquid crystal display 35 that displays a map and a guided route to a destination for the user; a speaker 36 that outputs audio guidance regarding route guidance; a DVD drive 37 that reads a DVD which is a storage medium; and a communication module 38 that performs communication with the server device 1, a VICS center, etc. (As used herein, the term “storage medium” includes all tangible media capable of storing computer-readable data, but does not include transitory signals.)

The components included in the navigation device 5 will be described in turn below.

The current location detecting part 31 includes a GPS 41, a vehicle speed sensor 42, a steering sensor 43, a gyro sensor 44, etc., and can detect a current vehicle location and orientation, vehicle travel speed, a current time, etc. Here, particularly, the vehicle speed sensor 42 is a sensor for detecting the moving distance and vehicle speed of the vehicle, and generates pulses according to the rotation of drive wheels of the vehicle and outputs a pulse signal to the navigation ECU 33. Then, the navigation ECU 33 counts the generated pulses and thereby calculates the rotational speed of the drive wheels and moving distance. Note that the navigation device 5 does not need to include all of the above-described four types of sensors, and the navigation device 5 may be configured to include only one or a plurality of types of sensors among those sensors.

In addition, the data recording part 32 includes a hard disk (not shown) serving as an external storage device and a recording medium; and a recording head (not shown) which is a driver for reading a terminal-side map DB 45, a delivery information DB 46, a predetermined program, and the like, which are recorded on the hard disk, and writing predetermined data to the hard disk. Note that the data recording part 32 may be composed of a nonvolatile memory, a memory card, or an optical disc such as a CD or a DVD, instead of a hard disk.

Here, the terminal-side map DB 45 is storage means for storing map information used for a route search and travel guidance performed on a communication terminal 7. Note that when map information is obtained from an external server, the terminal-side map DB 45 is not necessarily required.

In addition, the delivery information DB 46 is storage means for storing delivery information (assistance information about roads) delivered from the server device 1.

Meanwhile, the navigation ECU (electronic control unit) 33 is an electronic control unit that performs overall control of the navigation device 5, and includes a CPU 51 serving as a computing device and a control device; and internal storage devices such as a RAM 52 that is used as a working memory when the CPU 51 performs various types of arithmetic processing and that stores route data obtained when a route is searched for, etc., a ROM 53 having recorded therein a program for control, etc., and a flash memory 54 that stores a program read from the ROM 53.

The operating part 34 is operated, for example, when a point of departure which is a travel start point and a destination which is a travel end point are inputted, and includes a plurality of operating switches such as various types of keys and buttons (not shown). Then, based on switch signals outputted by, for example, depression of various switches, the navigation ECU 33 performs control to perform corresponding various types of operation. Note that the operating part 34 may include a touch panel provided on the front of the liquid crystal display 35. Note also that the operating part 34 may include a microphone and an audio recognition device.

In addition, on the liquid crystal display 35 are displayed a map image including roads, traffic information, operation guidance, an operation menu, guidance on keys, a guided route from a point of departure to a destination, guidance information according to the guided route, news, weather forecasts, time, emails, TV programs, etc. Note that a HUD or an HMD may be used instead of the liquid crystal display 35.

In addition, the speaker 36 outputs audio guidance that provides guidance on travel along a guided route or guidance on traffic information, based on an instruction from the navigation ECU 33.

In addition, the DVD drive 37 is a drive that can read data recorded on a recording medium such as a DVD or a CD. Then, based on the read data, for example, music or video is played back or the terminal-side map DB 45 is updated. Note that instead of the DVD drive 37, a card slot for performing reading and writing on a memory card may be provided.

In addition, the communication module 38 is a communication device for receiving various information, e.g., map update information, assistance information, and traffic information which are transmitted from the server device 1, a VICS center, a map delivery center, etc., and corresponds to, for example, a mobile phone or a DCM.

Next, the probe information statistical processing program which is executed by the CPU 21 in the server device 1 included in the route search system 2 according to the present embodiment having the above-described configuration will be described based on FIG. 8. FIG. 8 is a flowchart of the probe information statistical processing program according to the present embodiment. Here, the probe information statistical processing program is a program that is executed at predetermined time intervals (e.g., 24-hour intervals), and calculates the means and standard deviations of travel times for a link which serve as a calculation material for cost values by gathering statistics of probe information collected from each vehicle 4, and collects the means and the standard deviations in a DB. Note that the program shown in flowcharts of the following FIGS. 8 and 9 is stored in the RAM 22 or the ROM 23 included in the server device 1, and executed by the CPU 21.

Here, the probe information statistical processing program gathers statistics of probe information such that the probe information is segmented by each link and each combination of an entry link and an exit link for the link. Therefore, processes at and after the following step (hereinafter, abbreviated as S) 1 are repeatedly performed for each link present across the country and each combination of an entry link and an exit link for the link. For example, when the processes are performed for the link C shown in FIG. 3, since the link A and the link B are present as entry links and the links D to F are present as exit links, the processes are repeatedly performed for six (=2×3) patterns which are combinations of an entry link and an exit link. Note that the configuration may be such that the probe information is further segmented by time period or day. Note also that the probe information may be prepared so as to be segmented by each link and each exit link without segmented by entry link, or may be prepared so as to be segmented by each link and each entry link without segmented by exit link.

First, at S1, the CPU 21 extracts probe information corresponding to a processing-target link and a processing-target combination of an entry link and an exit link, among the probe information stored in the probe information DB 12.

Then, at S2, the CPU 21 identifies a distribution of travel times required for each vehicle to pass through the processing-target link from the probe information obtained at the above-described S1 (see FIG. 3), and calculates a mean μ as a representative value of the travel times. When 100 pieces of probe information are obtained at the above-described S1, a mean of 100 travel times is calculated.

Subsequently, at S3, the CPU 21 calculates a standard deviation σ as a value representing statistical variation of the travel times. When 100 pieces of probe information are obtained at the above-described S1, a standard deviation of 100 travel times is calculated. Note that the larger the variation of the travel times of the vehicles 4, the larger the standard deviation, too.

Thereafter, at S4, the CPU 21 stores the mean and standard deviation of the travel times for the link calculated at the above-described S2 and S3 in a DB as link data 27 such that the mean and the standard deviation are associated with the link and the combination of an entry link and an exit link (see FIG. 6). Note that the link data stored at the above-described S4 is used to identify cost values used when a route search process is performed as will be described later.

Next, the route search processing program executed by the CPU 21 in the server device 1 will be described based on FIG. 9. FIG. 9 is a flowchart of the route search processing program according to the present embodiment. Here, the route search processing program is a program that is executed when a route search request is received from a navigation device 5, and searches for a recommended route from a point of departure to a destination, using the means and standard deviations of travel times for links calculated using the aforementioned probe information statistical processing program (FIG. 8).

First, at S11, the CPU 21 receives a route search request transmitted from a navigation device 5. Note that the route search request includes a terminal ID that identifies the navigation device 5 which is the source of the route search request; and information identifying a point of departure (e.g., the current vehicle location) and a destination which are search conditions for a route search.

Thereafter, at S12, the CPU 21 extracts each link that is present between the point of departure and the destination and that can form a recommended route, based on the network data 26 included in the server-side map information 25 and the point of departure and destination received at the above-described S1. Then, link data 27 for each of the extracted links is obtained from the server-side map information 25. Here, in the link data 27, the mean and standard deviation of travel times for a link are stored in advance so as to be associated with each other by the aforementioned probe information statistical processing program (FIG. 8).

Then, at S13, the CPU 21 performs a route search process for a route from the point of departure to the destination which are obtained at the above-described S11, using the mean and standard deviation of travel times for each link obtained at the above-described S12. Specifically, using publicly known Dijkstra's algorithm, a route with the smallest sum of cost values is determined to be a recommended route. Particularly, in the present embodiment, a sum S of cost values of a route is calculated by the following equation (1):

$$S = ( 1 - C ) {\sum }_{i = 0}^{N - 1} {μ}_{i} + C \sqrt{{\sum }_{i = 0}^{N - 1} {σ}_{i}^{2}} + {\sum }_{i = 0}^{N - 1} {extra}_{i} \qquad ( 1 )$$

A mean of travel times for each link forming a route:

μ₀,μ₁,μ₂, . . . ,μ_{N-1}

A standard deviation of the travel times for each link forming the route:

σ₀,σ₁,σ₂, . . . ,σ_{N-1}

A cost based on other factors for each link forming the route:

extra₀,extra₁,extra₂, . . . ,extra_{N-1}

A weight coefficient of variation of travel times: C

Note that in equation (1) C is the weight coefficient of variation of travel times and a value is set as appropriate in a range of 0 to 1. Specifically, C is a cost coefficient for adjusting whether to search for a route placing importance on obtaining an earlier arrival time at a destination or a reduction in error of an expected arrival time. For example, when C is closer to 1, the proportion of the standard deviations of travel times for a link sequence to the sum S of cost values increases, and thus, a route search is performed placing importance on a reduction in error of an expected arrival time. On the other hand, when C is closer to 0, the proportion of the means of travel times for a link sequence to the sum S of cost values increases, and thus, a route search is performed placing importance on obtaining an earlier arrival time.

In addition, in the present embodiment, even for the same link, the means and standard deviations of travel times for the link are identified, with travel times segmented by each entry link and each exit link. Therefore, at the above-described S13, the CPU 21 needs to select, as appropriate, the mean and standard deviation of travel times for a link to be substituted into equation (1) from among a plurality of candidates, based on the combinations of an entry link and an exit link.

In addition, the above-described equation (1) also takes into account the costs (extra) based on other factors for links. The costs include, for example, a cost based on the type of road, a cost based on the number of lanes, a cost based on the level of traffic congestion, and a cost based on the cost required to travel. Note, however, that cost values may be calculated using, as elements, only the means and standard deviations of travel times for links.

In addition, in the route search process at the above-described S13, for a link sequence in which there is a very low likelihood of vehicles stopping at traffic lights on the way due to signal control, etc., and a road event such as congestion affects the entire link sequence rather than on a link basis, the above-described route search process may be performed for a collection of a plurality of links included in the link sequence, as one link (combined link). In that case, in the aforementioned probe information statistical processing program (FIG. 8), for a combined link, the mean and standard deviation of travel times for a link are calculated for each combined link, and stored in the DB.

The following describes the route search process at the above-described S13 for a case of considering the above-described combined link, using a specific example.

The CPU 21 extends search branches by tracing nodes and links from a point of departure to a destination which are obtained at the above-described S11, provides a node of interest ahead of the search branches with candidate labels each representing a cumulative cost taken to reach the node and a search branch (i.e., a previous label), selects and determines a label that satisfies a predetermined condition (in the present embodiment, a label with the lowest cost) from among the provided candidate labels, and thereby finds a recommended route.

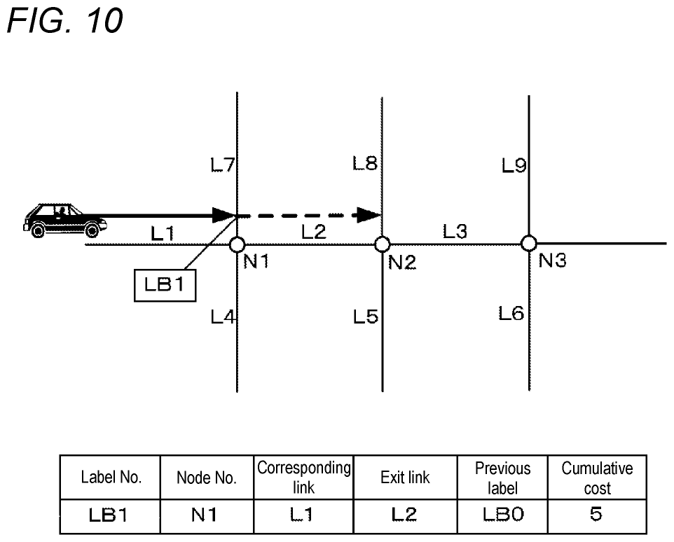

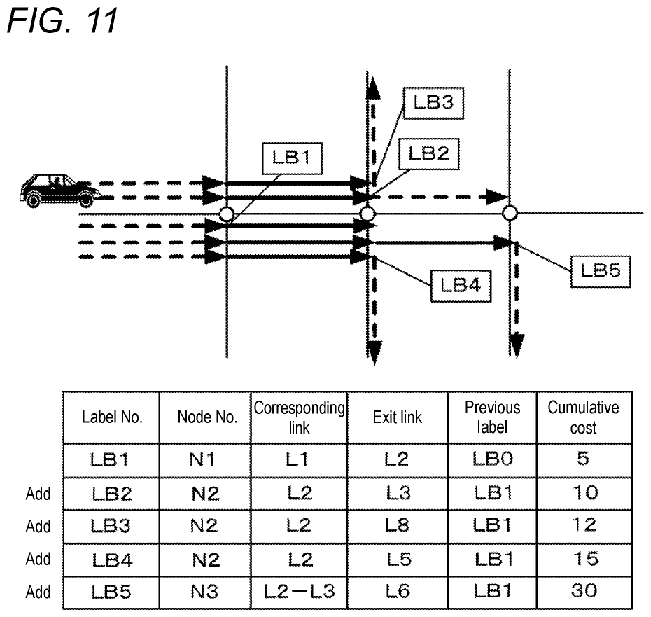

FIGS. 10 and 11 are illustrative diagrams showing a specific example of extending search branches in a route search process of the present embodiment. Here, in the present embodiment, in a label provided to each node, information is recorded based on link data 27, the information indicating a label number, a node number, a corresponding link, an exit link, a previous label number, and a cumulative cost. As shown in FIG. 10, it is assumed that a label LB1 (the corresponding link=a link L1 and the exit link=a link L2) provided to a node N1 is already determined. In that case, the CPU 21 extends search branches to a node present ahead of the exit link L2 of the label LB1. Specifically, the CPU 21 obtains link data including the exit link L2 of the label LB1 as a corresponding link and including the corresponding link L1 of the label LB1 as an entry link from the server-side map information 25, and provides candidate labels to a node to which the search branches are extended, based on the obtained link data. FIG. 11 shows an example in which candidate labels LB2, LB3, and LB4 are provided to a node N2 based on single-link information, and a candidate label LB5 is provided to a node N3 based on combined-link information. The labels LB2, LB3, and LB4 have the common corresponding link L2 and have different exit links. In addition, the label LB5 includes two corresponding links L2 and L3 and has a link L6 as an exit link.

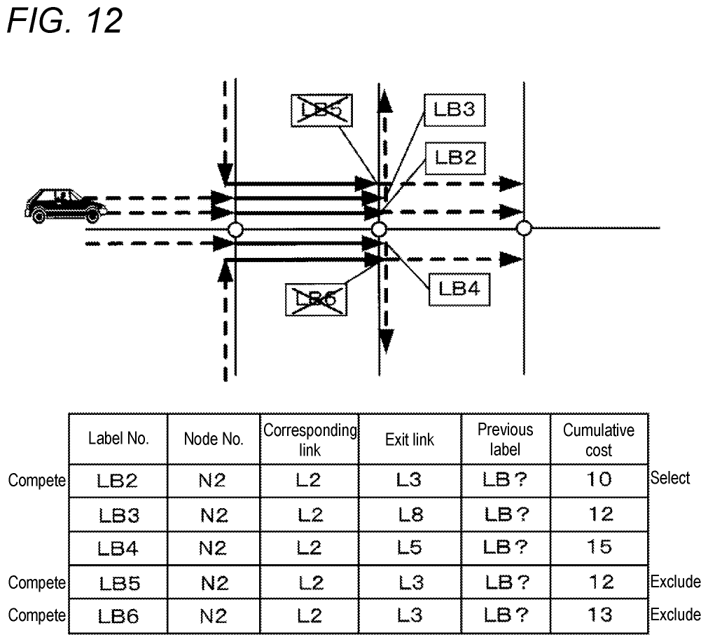

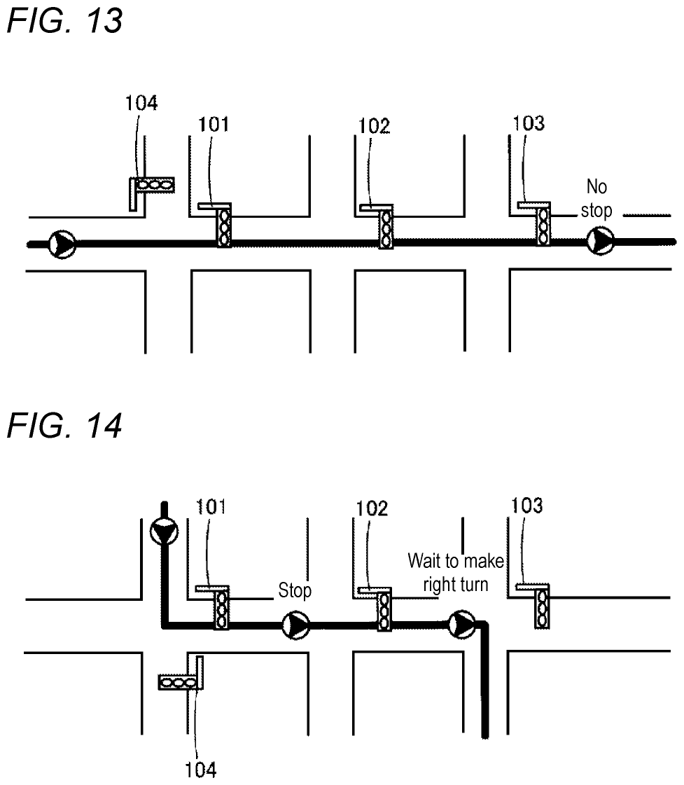

Next, FIG. 12 is an illustrative diagram showing a method of excluding unnecessary labels from among candidate labels provided to a node of interest in the route search process of the present embodiment. When there are labels whose combinations of a corresponding link and an exit link compete against each other at a node of interest, the CPU 21 compares cumulative costs of the labels, and selects a label with the lowest cumulative cost as a candidate label for the node of interest. Those levels not selected are excluded from the candidate labels. By doing so, a search branch is not extended from a label with a high cumulative cost. In the example shown in FIG. 12, the labels LB2, LB5, and LB6 provided to the node N2 compete against each other in their combinations of a corresponding link (link L2) and an exit link (link L3). Hence, a route searching part 206 compares cumulative costs of the labels, selects the label LB2 with the lowest cumulative cost as a candidate label, and excludes other labels LB5 and LB6 from the candidate labels.

Thereafter, in the same manner as above, according to the technique shown in FIGS. 10 to 12, search branches are extended from the point of departure to each node, and a label with the lowest cost is determined one by one from among candidate labels provided to each node. Then, a route that connects corresponding links included in the determined labels is searched for as a recommended route.

Thereafter, at S14, the CPU 21 delivers the recommended route searched for at the above-described S13 to the navigation device 5 from which the route search request is provided. Then, the navigation device 5 to which the recommended route is delivered provides guidance of the delivered recommended route to the user through the liquid crystal display 35, etc. Then, the recommended route guided is set as a guided route of the navigation device 5 based on a user operation performed thereafter, and travel guidance based on the set guided route is provided.

Note that the configuration may be such that the above-described route search process (S13) is performed by the navigation device 5 instead of the server device 1. In that case, the configuration is such that the means and standard deviations of travel times for links calculated by the probe information statistical processing program (FIG. 8) are delivered to the navigation device 5 from the server device 1. In addition, the configuration may be such that the probe information statistical processing program (FIG. 8) is also executed by the navigation device 5.

As described in detail above, in the server device 1 and a computer program executed by the server device 1 according to the present embodiment, the link data 27 included in the server-side map information 25 includes, for each entry link and each exit link, information that identifies a value representing statistical variation of travel times for a corresponding link, and a recommended route is searched for, using cost values identified based on a representative value of travel times for a link and a value representing statistical variation of the travel times (S11 to S14), and thus, the accurate value of variation of travel times for a link based on travel modes can be identified, and as a result, it becomes possible to identify more appropriate cost values. Then, by using the identified cost values, it becomes possible to rapidly search for a more appropriate recommended route for the user.

Note that it is, of course, possible to make various modifications and alterations to the above-described embodiment without departing from the spirit and scope of the broad inventive principles.

For example, although one server device 1 performs each of a process of gathering statistics of probe information and a process of searching for a recommended route, the process of gathering statistics of probe information and the process of searching for a recommended route may be performed by different server devices. For example, the server device 1 may receive statistical results of probe information obtained by another server device and perform a route search process.

In addition, although, in the present embodiment, the mean and standard deviation of travel times for a link are associated with link data and collected in a DB, only a standard deviation of travel times for a link may be associated and collected in a DB. In that case, for example, a mean of travel times for a link may be calculated from probe information upon a route search. In addition, for the representative value of travel times for a link, a median or a mode may be used instead of a mean. Likewise, for the value representing statistical variation of travel times for a link, a variance may be used instead of a standard deviation. Furthermore, instead of the mean and standard deviation of travel times for a link, a link cost value calculated based on the mean and standard deviation of travel times for a link may be associated and collected in a DB.

In addition, although, in the present embodiment, the mean and standard deviation of travel times for a link are collected in a DB for each combination of an entry link and an exit link so as to be collectively associated with link data, for example, the mean and standard deviation of travel times for a link may be separately collected in DBs. In addition, for each link, the mean and standard deviation of travel times for the link for one combination of an entry link and an exit link (e.g., a combination of an entry link and an exit link that pass through the link straight ahead) may be collected in a DB as reference values, and for other combinations, differences from the reference values or coefficients may be stored instead of direct values.

In addition, although, in the present embodiment, probe information is used as a material for calculating the means and standard deviations of travel times for a link, the configuration may be such that VICS information or other traffic information is used instead. Furthermore, the means and standard deviations of travel times for a link may be calculated from the past travel history of a vehicle that performs a route search.

In addition, although, in the present embodiment, the subject that executes the probe information statistical processing program shown in FIG. 8 and the route search processing program shown in FIG. 9 is the server device 1 in the probe center 3, the configuration may be such that the navigation device 5 executes a part or all of those programs. In addition, it is also possible to form the route search system 2 using, instead of the navigation devices 5, other devices having the route search function. For example, mobile phones, smartphones, tablet terminals, personal computers, etc., can be used.

In addition, although an implementation example in which the route searching device is embodied is described above, the route searching device can also have the following configurations, and in that case, the following advantageous effects are provided.

For example, a first configuration is as follows:

There are included information obtaining means (21) for obtaining network data (26) including nodes and links that represent a road network, and link information (27) including travel times for traveling a link included in the network data; and route searching means (21) for searching for a recommended route taking into account a travel time to a destination, based on the network data and the link information, and the link information includes, for each entry link or each exit link, information that identifies a value representing statistical variation of travel times for the link, the entry link being a link entering a node at one end of the link, and the exit link being a link exiting from a node at the other end of the link, and the route searching means searches for the recommended route using cost values identified based on a representative value of travel times for a link and a value representing statistical variation of the travel times.

According to a route searching device having the above-described configuration, a link for which costs are to be identified is allowed to have information associated therewith that identifies statistical variation of travel times for the link, with travel times segmented by each entry link or each exit link. By this, the accurate value of variation based on travel modes can be identified, and as a result, it becomes possible to identify more appropriate cost values. Then, by using the identified cost values, it becomes possible to rapidly search for a more appropriate recommended route for the user.

In addition, a second configuration is as follows:

There is included storing means (21) for storing, in a storage medium (13), a representative value of travel times for a link and a value representing variation of travel times for a link such that the values are associated with an entry link or an exit link, and the route searching means (21) identifies cost values using the values stored in the storage medium, and searches for the recommended route.

According to a route searching device having the above-described configuration, by collecting parameters regarding travel times which are used in a route search process in a database in advance, it becomes possible to reduce the processing load of the route search process. In addition, it becomes also possible to reduce the time taken for the route search process. Furthermore, by delivering information collected in the database, it also becomes possible for a device to which the information is delivered to perform the same route search.

In addition, a third configuration is as follows:

The cost values are identified based on a function including a representative value of travel times for a link, a value representing variation of travel times for a link, and a weight coefficient of variation of travel times for a link.

According to a route searching device having the above-described configuration, by setting the weight coefficient of variation as appropriate, it becomes possible to adjust whether to search for a route placing importance on obtaining an earlier arrival time at a destination or a reduction in error of an expected arrival time. Therefore, it becomes possible to search for a route that meets a user's desire to a greater extent.

In addition, a fourth configuration is as follows:

The representative value of travel times for a link is a mean, a median, or a mode of the travel times for the link which is obtained by gathering statistics of probe information obtained from vehicles.

According to a route searching device having the above-described configuration, by using cost values that take into account the mean, median, or mode of travel times for a link, it becomes possible to search for a recommended route, given priority to obtain an earlier arrival time at a destination.

In addition, a fifth configuration is as follows:

The value representing variation of the travel times for the link is a standard deviation of the travel times for the link which is obtained by gathering statistics of probe information obtained from vehicles.

According to a route searching device having the above-described configuration, by using cost values that take into account the standard deviation of travel times for a link, it becomes possible to search for a recommended route, given priority to reduce error of an arrival time at a destination.

1. A route searching device comprising:
a processor programmed to:
obtain network data including nodes and links, and link information including:
travel times for traveling a link included in the network data, the nodes and the links representing a road network; and
for each entry link or each exit link, information that identifies a value representing statistical variation of travel times for the link, the entry link being a link entering a node at one end of the link, and the exit link being a link exiting from a node at another end of the link; and
search for a recommended route by taking into account:
a travel time to a destination, based on the network data and the link information; and
cost values identified based on a representative value of travel times for a link and a value representing statistical variation of the travel times.

2. The route searching device according to claim 1, wherein:
the processor is programmed to store, in a storage medium, a representative value of travel times for a link and a value representing variation of travel times for a link such that the values are associated with an entry link or an exit link;
identify the cost values using the values stored in the storage medium.

3. The route searching device according to claim 1, wherein the cost values are identified based on a function including a representative value of travel times for a link, a value representing variation of travel times for a link, and a weight coefficient of variation of travel times for a link.

4. The route searching device according to claim 1, wherein the representative value of travel times for a link is a mean, a median, or a mode of the travel times for the link, the mean, the median, or the mode being obtained by gathering statistics of probe information obtained from vehicles.

5. The route searching device according to claim 1, wherein the value representing variation of the travel times for the link is a standard deviation of the travel times for the link, the standard deviation being obtained by gathering statistics of probe information obtained from vehicles.

6. A computer-readable storage medium storing a computer-executable program for causing a computer to perform functions comprising:
obtaining network data including nodes and links, and link information including:
travel times for traveling a link included in the network data, the nodes and the links representing a road network; and
for each entry link or each exit link, information that identifies a value representing statistical variation of travel times for the link, the entry link being a link entering a node at one end of the link, and the exit link being a link exiting from a node at another end of the link; and
searching for a recommended route by taking into account:
a travel time to a destination, based on the network data and the link information; and
cost values identified based on a representative value of travel times for a link and a value representing statistical variation of the travel times.
